(19) United States
(12) Patent Application Publication
(10) Pub. No.: US 2023/0403637 A1
(43) Pub. Date: Dec. 14, 2023

(54) ENHANCED WIRELESS TRANSMISSION SYSTEM

(71) Applicant: Microsoft Technology Licensing LLC, Redmond, WA (US)

(72) Inventors: Amer Aref Hassan, Kirkland, WA (US); David Anthony Lickorish, Sammamish, WA (US); Edward C. Giaimo, III, Bellevue, WA (US)

(21) Appl. No.: 17/837,600

(22) Filed: Jun. 10, 2022

(51) Int. Cl. H04W 48/16; H04W 48/08; H04L 5/00; H04L 1/18

(52) U.S. Cl. CPC H04W 48/16; H04W 48/08; H04L 5/0048; H04L 1/1812

(57) ABSTRACT

Disclosed in some examples are methods, systems, devices, and machine-readable mediums in which an ad-hoc neighbor group of wireless devices provides a retransmission service to a first wireless device in the neighboring group over an out-of-band wireless protocol. That is, a first transmission from a transmitter to the first wireless device over a first wireless protocol may be received by a second wireless device in a neighboring group of wireless devices. The second wireless device may then retransmit information (e.g., packets) from the first transmission to the first wireless device over a second wireless protocol and/or channel. Thus, for example, a second wireless device may receive a satellite signal sent to the first wireless device and provide a retransmission of the signal or information from the signal to the first wireless device over a Wi-Fi direct protocol.

### TECHNICAL FIELD

Embodiments pertain to enhancing the reliability of a wireless communication system. Some embodiments relate to utilizing wireless ad-hoc networks to retransmit packets over a first wireless protocol that were originally transmitted over a second wireless protocol.

### BACKGROUND

Wireless communications are ubiquitous throughout our lives. Various wireless transmissions from satellites orbiting the earth, wireless cellular base stations, and Wi-Fi access points provide data to users across the globe. Computing devices, such as mobile phones, may use these transmissions to provide voice and data services to users wherever they are.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1 and 2 illustrate two examples of neighbor device groups according to some examples of the present disclosure.

FIG. 3 illustrates a diagram of a series of data structures for storing neighbor information according to some examples of the present disclosure.

FIG. 4 illustrates a logical diagram of an enhanced wireless transmission system according to some examples of the present disclosure.

FIG. 5 illustrates a logical diagram of a computing device according to some examples of the present disclosure.

FIG. 6 illustrates a diagram of a retransmission system according to some examples of the present disclosure.

FIG. 7 illustrates a flowchart of a method of retransmission of packets using an out-of-band wireless protocol according to some examples of the present disclosure.

FIG. 8 illustrates a flowchart of a method 800 of a first computing device receiving a retransmission from a second computing device according to some examples of the present disclosure.

FIG. 9 is a block diagram illustrating an example of a machine upon which one or more embodiments may be implemented.

### DETAILED DESCRIPTION

One issue with wireless transmissions is that the wireless environment in certain areas may be suboptimal. For example, inner city environments are challenging for both cellular and satellite transmissions. The buildings in these environments may block the wireless signal creating dead zones, reflect them creating multi-path interference, or attenuate the signal creating a weaker received signal. These issues may cause packets to be lost and retransmissions to be necessary. For some wireless protocols, such as satellite protocols, retransmissions may not be possible. In situations where retransmissions are possible, the distance between the transmitter and receiver are often large and the latency is thus high. Moreover, the request for a retransmission, and the retransmission itself may be sent in the same sub-par wireless environment as the original transmissions. For real-time services, this may cause stuttering and jitter which may ruin the immersive experiences these real-time services seek to create.

Disclosed in some examples are methods, systems, devices, and machine-readable mediums in which an ad-hoc neighbor group of wireless devices provides a retransmission service to a first wireless computing device (hereinafter the recipient wireless computing device) in the neighboring group over an out-of-band wireless protocol. That is, a first transmission from a transmitter (hereinafter original transmitter) to the first wireless device over a first wireless protocol may be received by a second wireless device in a neighboring group of wireless devices. The second wireless device may then retransmit information (e.g., packets) from the first transmission to the first wireless device over a second wireless protocol and/or channel. Thus, for example, a second wireless device may receive a satellite signal sent to the first wireless device and provide a retransmission of the signal or information from the signal to the first wireless device over a Wi-Fi direct protocol.

The present disclosure thus solves the technical problem of wireless interference and poor signal quality with the technical solution of ad-hoc wireless retransmissions on an out-of-band wireless protocol and/or channel. This solution allows for more reliable wireless communications in areas where the wireless signal may be inconsistent.

In some examples, the computing devices in the neighbor group may receive the original transmissions to the recipient wireless computing device and may temporarily store the original transmissions based upon the knowledge that the transmission is addressed to, or otherwise directed to, a wireless device within the neighboring group of wireless devices. Upon receiving an explicit retransmission request, one or more neighboring devices may send a retransmission. Once the retransmission is sent, or once a specified time period has expired, the neighboring devices may delete these buffered transmissions to free up additional memory. Thus, devices in the neighbor group may buffer packets sent to other wireless devices within the neighbor group and retransmit those packets over a different wireless channel and/or with a different wireless protocol.

In other examples, the neighboring devices may receive the original transmissions to the recipient wireless computing device and may automatically retransmit the original transmissions based upon the knowledge that the transmission is addressed or otherwise directed to the recipient wireless computing device within the neighboring group of wireless devices. The retransmissions may be delayed by a random value to prevent overlapping retransmissions from other devices within the neighbor group. If the recipient wireless computing device received the original transmission without errors, the recipient may just ignore the duplicative transmissions from the neighboring group.

A neighboring device may always provide the retransmissions; may provide the retransmissions when the device is not actively transmitting or receiving its own data (e.g., the transmitter has been idle for a predetermined period of time or has transmitted or received less than a threshold amount of data over a predetermined period of time); when the device has sufficient battery capability; when it has sufficient battery capability (e.g., over a threshold amount of battery life left) and when it is not actively transmitting and receiving its own data; and the like. In some examples, the retransmission may use a connectionless protocol, such as User Datagram Protocol (UDP) to reduce network traffic that would be caused by the control data used by a connection-based protocol such as Transmission Control Protocol (TCP).

In some examples, the devices within a neighbor group discover (e.g., through discovery messages) wireless addresses of the other devices for one or more wireless protocols. The devices within a neighbor group then scan for the signals addressed to these addresses for each device within the neighbor group. If a first wireless device receives a signal for a second wireless device within the same neighbor group as the first wireless device, the first wireless device may retransmit the signal. In some examples, this happens automatically. In other examples, the second wireless device may specify transmissions that other devices in the neighbor group should monitor and retransmit. For example, the second wireless device may be having reception issues for a particular transmission and so it may request that other devices within the neighbor group that receive signals of that transmission addressed to it retransmit them to the second wireless device (either automatically, or when a retransmission is requested).

In some examples, each neighboring device may scan for, and buffer, transmissions addressed to all other devices within the group of neighboring devices. In other examples, one or more neighboring group devices may create communication pairs. Each device in the pair of devices listens for packets for the other device in the pair and forwards that packet to the other device in the pair. Various devices within the neighbor group pair up in such a fashion. The pairs may change as one or more devices leaves the neighbor group or if one device in the pair is not able to receive a quality signal for the other device in the pair (e.g., as measured by received signal strength, quality, or other metric). In some examples, the pairs may be selected based upon a predicted stability (e.g., that they are likely to be within the same neighbor group for the longest time of all devices—as determined by their current location, motion information, and the like); based upon relative signal strength of the primary transmission (e.g., one device in the pair may have a good signal from the primary transmission—but may not be actively receiving from the primary transmitter while the other device may have a poor signal and be actively receiving); or the like. As described, communication pairs may be used, but in other examples, three, four, or other numbers of devices may be used in a communication group.

As noted, neighbor groups may be based upon a relative location of the devices to each other. In other examples, neighbor groups may be based upon a property of one or more wireless channels or devices—such as a wireless transmission range of the second protocol used for retransmissions. In some examples, a neighbor group may be relative to a single device. That is, each device may have their own neighbor device groups. Thus, a single device may be part of several neighbor groups—some of which may have overlapping devices. In other examples, each device may be grouped together in a single neighbor group.

Devices within a neighbor group may retransmit signals or packets within the signals received over a first wireless channel or protocol over a second wireless channel or protocol. Example second protocols may include short-range wireless protocols such as a Wi-Fi, Bluetooth, or RFID protocol. In some examples, these short-range wireless protocols may have a wireless range in a typical environment and with typical hardware of approximately 100 meters or less. These short-range wireless protocols are contrasted with longer range protocols such as typical cellular base stations, satellite transmitters, and the like which have the capability of communicating over large areas.

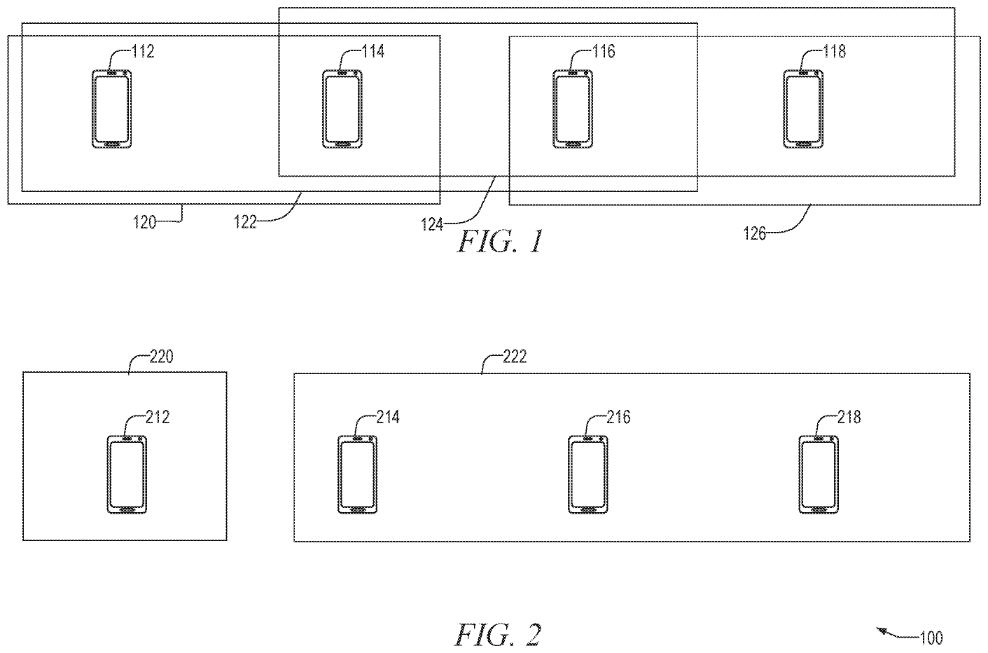

FIGS. 1 and 2 illustrate two examples of neighbor device groups according to some examples of the present disclosure. Computing devices 112, 114, 116, and 118 of FIG. 1 may be part of multiple neighbor groups. Each neighbor group may be developed relative to that particular computing device. For example, computing device 116 may have a neighbor group denoted by box 124 made up of computing devices 114 and 118. Similarly computing device 114 may have a neighbor group denoted by box 122 including computing devices 112 and 116. Computing device 112 may have a neighbor group denoted by box 120 made up of computing devices 114 and potentially other devices (not shown). Computing device 118 may have a neighbor group denoted by box 126 comprising computing device 116 and potentially other devices (not shown). Thus, computing device 116 may be part of three separate neighbor groups.

FIG. 2 illustrates an example in which only a single neighbor group per-computing device is used. Thus, computing device 212 is part of its own neighbor group shown by box 220 (potentially with other, not-shown devices) while computing devices 214, 216, and 218 are part of a single neighbor group shown by box 222.

Neighbor groups may be formed using one or more wireless messages using one or more wireless protocols. For example, one or more discovery messages may be broadcast by a first wireless device. Other wireless devices that receive the message (or receive the message at a power level over a predetermined threshold power level) may respond with a discovery response message. These messages may include contact details such as wireless addresses for the first wireless device for the wireless protocols for which it can communicate. Other information included may include a computing device location, and the like. These messages may also include details such as wireless addresses and other contact information. In additional examples, the discovery messages may include capability discovery. For example, to discover a set of supported wireless protocols of each wireless device.

Devices may be considered within a neighbor group if they respond to a discovery broadcast message. In other examples, devices may only be grouped together if they are within a predetermined threshold distance of each other as determined by a Global Navigation Satellite System (GNSS) or other position sensor. As noted, the discovery response messages may include the responding device's location.

In other examples, other algorithms for neighbor discovery may be used such as a Wi-Fi EasyMesh® algorithm. In EasyMesh, proximity may be established within a proximity radius determined by the transmit RF powers of the devices as well as the frequency spectrum. For example, for larger radiuses, lower frequency spectrum such as 800 MHz or 900 MHz may be used.

In some examples, the neighbor groups may utilize mesh networking and routing techniques. Thus, a first wireless device that is not in direct wireless communication contact with a second wireless device may be a part of a neighbor group even if the first and second wireless devices are not in direct wireless communication. The first wireless device may route retransmissions through multiple wireless devices in the neighboring group. For example, the request for retransmission may be sent by the second computing device to a third computing device, and the third computing device may forward it to the first computing device. Example mesh protocols include Linux Wireless Extension, Apple Multi Peer connectivity, and the like. Example mesh network routing protocols include associativity based routing (ABR), ad hoc on-demand distance vector (AODV), Better Approach to Mobile Adhoc Networking (BATMAN), and the like.

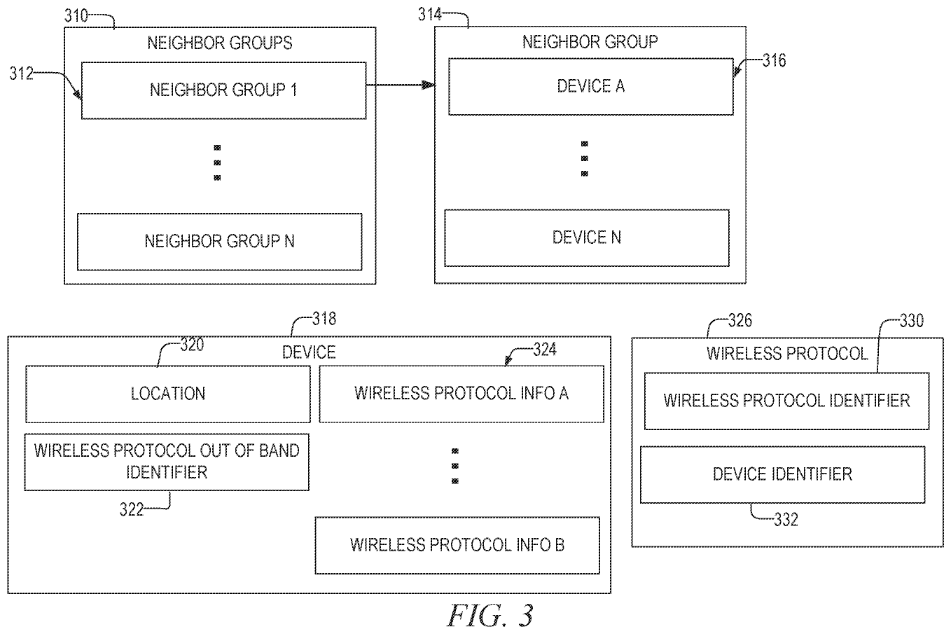

FIG. 3 illustrates a diagram of a series of data structures for storing neighbor information according to some examples of the present disclosure. Neighbor groups data structure 310 may include a linked list 312 of neighbor group data structures 314. Each neighbor group data structure 314 includes a linked list 316 of device data structures 318 that describe devices within that neighbor group. Device data structure 318 may include a device location 320 that indicates the location of the device as determined from messages from the device, a wireless protocol out of band identifier that identifies the preferred out of band wireless protocol with which to send retransmissions, and a linked list 324 of wireless protocol information data structures 326. The wireless protocol out of band identifier may be a pointer to wireless protocol information data structure 326 of the linked list 324. Wireless protocol information data structures 326 may include a wireless protocol identifier 330 which may specify the wireless protocol (e.g., Wi-Fi, 3G, 4G, 5G cellular, satellite, Bluetooth, RFID, or the like). The device identifier 332 may include one or more device identifiers within that protocol. For example, an IP address, a wireless MAC address, a user equipment identifier, or the like. These identifiers may be determined during the neighbor group discovery process and may allow the device to monitor for communications to the particular device as well as send retransmissions across the out-of-band wireless protocol.

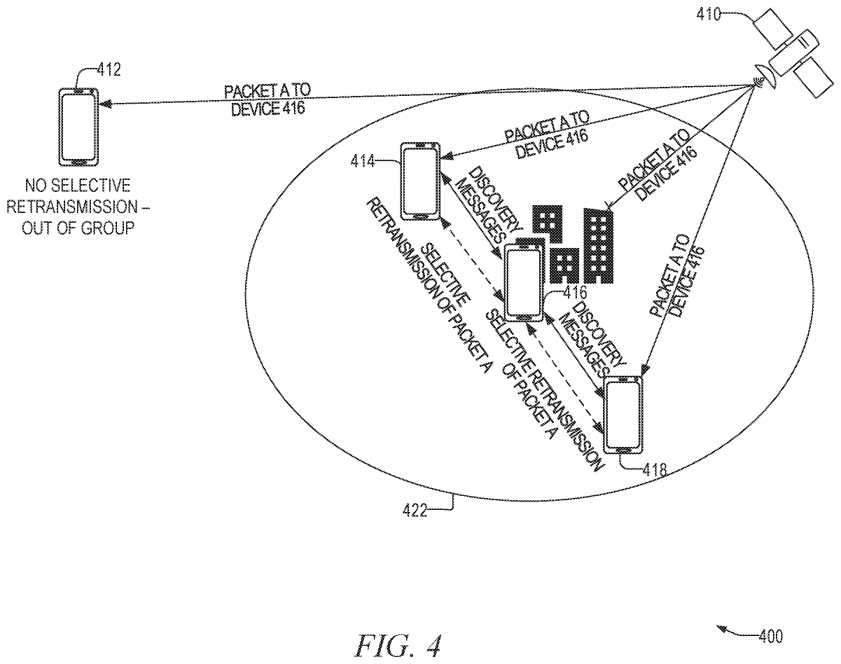

FIG. 4 illustrates a logical diagram of an enhanced wireless transmission system 400 according to some examples of the present disclosure. Computing devices 414, 416, and 418 are within a neighbor group 422. The neighbor group is created using one or more discovery messages. The transmitter 410 is sending signals with packets, such as packet A to the computing device 416. Computing device 416 may be in an urban environment where line of sight with the transmitter 410 was lost or were multi-path reflections cause interference such that the computing device 416 is unable to receive the packet A. Computing device 416 may recognize that the wireless signal meets a low-quality criterion using one or more wireless signal measurements (e.g., Received Signal Strength, packet error rate, bit error rate, or the like). As a result, in some examples, computing device 416 may request assistance from one or more devices within the neighbor group 422.

Computing devices 414 and/or 418 of the neighbor group 422 may be in a place that allows for successful reception of the signal from the transmitter 410. In these examples, one or both of, the computing devices 414 and 418 may retransmit information from the signal (e.g., packet A) to the computing device 416 using an out-of-band wireless protocol. The out-of-band wireless protocol is out-of-band to the original wireless transmission in that it uses a different wireless protocol and/or a different wireless channel. Computing device 412, which is not within the neighbor group 422 (e.g., it may not be within a wireless protocol range of the out-of-band protocol) and so it does not retransmit the packet to the computing device 416. Because the retransmission is out-of-band, and because different frequencies respond to interference differently, the out-of-band signal may more reliably transmit the retransmissions. Furthermore, each wireless protocol is different and some may be more suited to certain environments over others. Finally, in some examples, the distances between the devices that are retransmitting and the recipient device may be lesser than the distance between the original transmitter and the recipient device. This decreased distance may be allow the retransmission to be successful.

As noted, the neighbor group 422 may be formed using one or more wireless messages exchanged between the computing devices 416, 414, and 418. In some examples, these messages may be over a first wireless protocol and/or channel and the transmission from transmitter 410 may be over a second wireless protocol and/or channel. In some examples, the retransmission may be over the first wireless protocol and/or channel; the second wireless protocol and/or channel; or a third wireless protocol and/or channel.

While the present disclosure uses a decentralized ad-hoc approach to forming neighbor groups, in other examples, one or more computing devices may provide a centralized neighbor group service. Computing devices may register with the neighbor group service and provide location updates. Based upon the locations of the computing device the neighbor group service may assign each computing device to a neighbor group. These groups may then be communicated to the devices. Example group services may reside at cellular base stations, Wi-Fi access points, other computing devices, or the like.

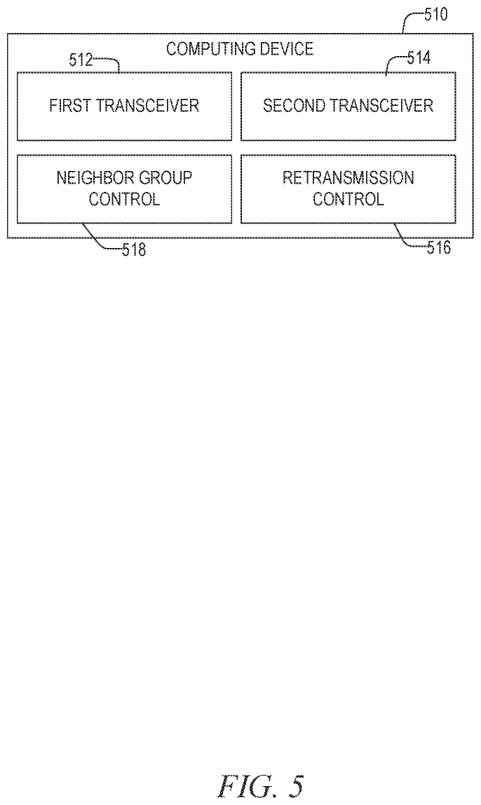

FIG. 5 illustrates a logical diagram of a computing device according to some examples of the present disclosure. The first transceiver 512 may transmit and receive on a first wireless protocol. The second transceiver 514 may transmit and receive on a second wireless protocol, different than the first wireless protocol. The neighbor group control component 518 may be responsible for discovering and maintaining one or more neighbor groups. For example, the neighbor group control component 518 may send one or more discovery broadcast messages using the first transceiver 512 or the second transceiver 514. Discovery response messages may then be received by that transceiver and processed by the neighbor group control component 518. The discovery messages may include information on wireless protocols and capabilities supported by the computing device, how to reach the computing device on those protocols, and the like. The discovery response messages may include information on the wireless protocols and capabilities supported by the responding computing device, and in some examples the location of the responding computing device. These response messages may be used by the neighbor group control component to fill in the data structures shown in FIG. 3.

Retransmission control component 516 may control the retransmission of packets to other computing devices in one or more neighbor groups. As noted, this may be done with the first transceiver 512 or the second transceiver 514—whichever is the out-of-band wireless protocol. This may be done in response to a request from a device within the neighboring group or may be done as a result of a random delay. In addition, retransmission control component 516 may control the request for and receipt of retransmissions from other computing devices. For example, if a packet is expected from a data stream received by the first transceiver 512 but did not make it, the retransmission control component 516 may request the packet from other computing devices in the neighbor group from the second transceiver 514. Once received, the retransmission control component 516 may insert that packet into the data stream. In other examples in which a retransmission request is not made, but retransmissions are done by other devices in the neighbor group automatically, the retransmission control component 516 may receive all the packets for a particular data stream and decide which packets, if any, were not received by the computing device. Those packets that are already received are ignored and those that are not received are processed and inserted into the appropriate data stream.

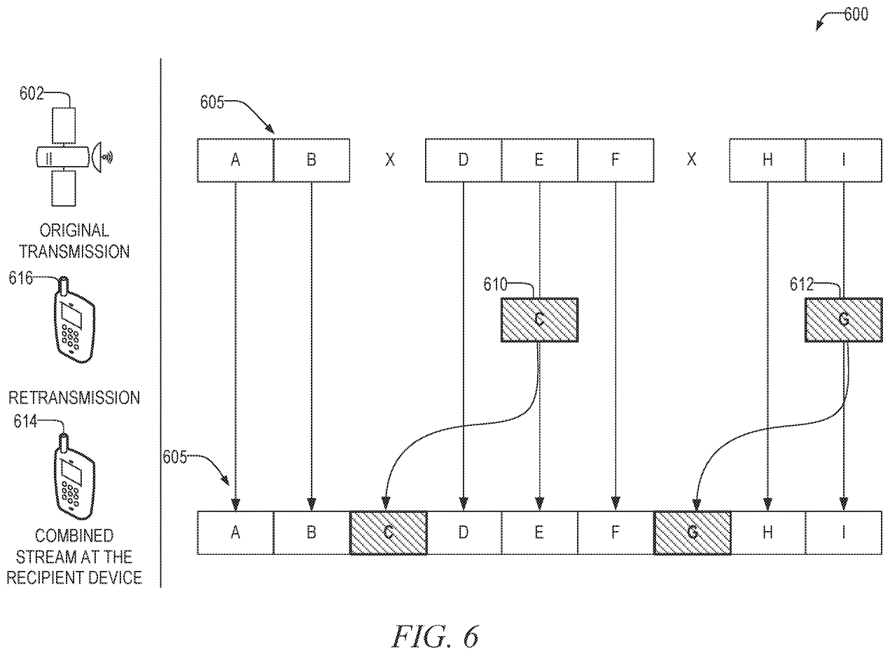

FIG. 6 illustrates a diagram 600 of a retransmission system according to some examples of the present disclosure. The original transmission sent by the original transmitter 602 is decoded to produce a stream or set of packets 605. Packets A, B, D, E, F, H, and I are successfully received by the recipient computing device 614. Packets C and G are not successfully received. In some examples, the packets were not able to be decoded, the packets may have had errors (e.g., failing Error Correction Code checking), or the like. The recipient computing device 614 reconstructs the full stream of data sent by the transmitter 602 at 605 using the stream 605 it successfully received from the original transmitter 602 and retransmissions of packet C 610 and packet G 612 from a neighbor computing device 616. This yields the entire packet stream. The retransmissions of packets C 610 and G 612 may be done at the request of the recipient computing device 614 or may be automatically retransmitted by the recipient computing device 614.

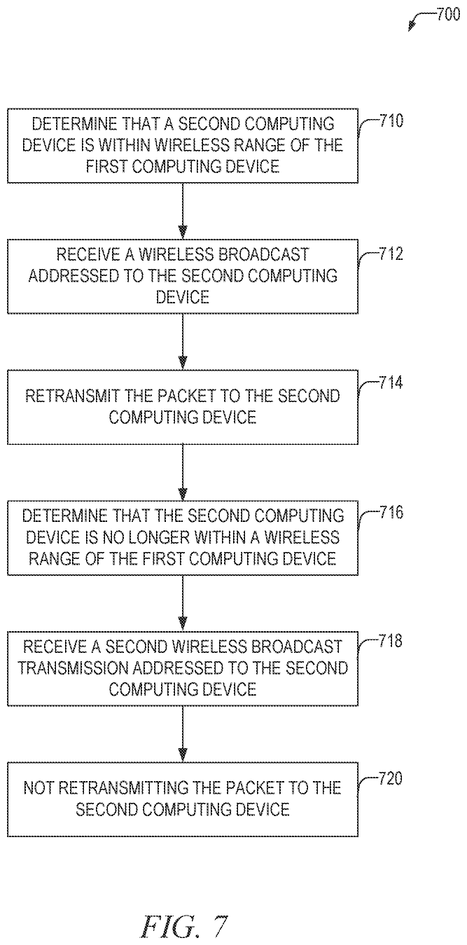

FIG. 7 illustrates a flowchart of a method 700 of retransmission of packets using an out-of-band wireless protocol according to some examples of the present disclosure. Method 700 may be performed by a first computing device that acts as a retransmitter to a second computing device within a neighbor group. At operation 710, the computing device may determine that a second computing device is within wireless range of the first computing device on a first wireless protocol (e.g., an out-of-band wireless protocol). For example, operation 710 may comprise forming one or more neighbor groups through exchanging wireless discovery and response messages. At operation 712, the computing device may receive a wireless transmission addressed to an address of the second computing device for a second wireless protocol and/or channel. The wireless transmission is a transmission that is sent to the second wireless device, but the first wireless device can receive this message (e.g., it's broadcast). The address of the second computing device on the second wireless protocol and/or second wireless channel may be exchanged during the neighbor group setup of operation 710, subsequent wireless messages, and the like. This exchange may allow the first computing device to scan for messages addressed to the second computing device over the second wireless protocol and/or channel. The computing device may tune, or otherwise direct a transceiver of the computing device to detect and/or decode signals sent from transmitters to the second wireless device on the second wireless protocol and/or the second wireless channel based upon identifying the second wireless device within the neighbor group of the first wireless device.

At operation 714, the first wireless computing device may retransmit information from the received wireless broadcast to the second computing device over the first wireless protocol. For example, a packet transmitted in the wireless broadcast. This retransmission may be responsive to the second computing device being determined to be within a wireless communication range of the first computing device. The retransmission may be responsive to a request for retransmission or may be done automatically without an explicit request for retransmission. In some examples, during neighbor group setup, the devices may exchange one or more keys or codes during neighbor group setup that are used to demodulate and/or receive signals over one or more wireless protocols.

At operation 716, the first wireless computing device may determine that the second computing device is no longer within a wireless range of the first computing device. For example, messages sent to the second computing device over the first wireless protocol are no longer received by the first or second wireless computing devices. For example, the neighbor group with the first and second wireless devices may periodically send status messages to determine whether they are still in wireless range of the first wireless protocol. Once the devices are no longer in range, the second computing device may be removed from the neighbor group of the first wireless computing device.

In other examples, the wireless messages exchanged over the first protocol may include a location of each wireless device. Devices over a threshold distance from each other may be dropped from a neighbor group. Still other examples utilize signal properties of the received status messages such as signal strength, signal quality, or the like to determine whether to keep a particular wireless device within a neighbor group. For example, one or more of these signal properties may be compared to one or more criteria to determine whether the criteria for keeping the device in the neighbor group is met. Criteria may include one or more thresholds, if-then rules, or the like that specify under which conditions a computing device may be added to a neighbor group, removed from a neighbor group, or remain in a neighbor group.

At operation 718, a second wireless broadcast transmission addressed to the second computing device may be received and decoded by the first computing device. At operation 720, information from the second wireless broadcast transmission may not be transmitted to the second wireless device due to the removal of the second wireless device from the neighbor group at operation 716.

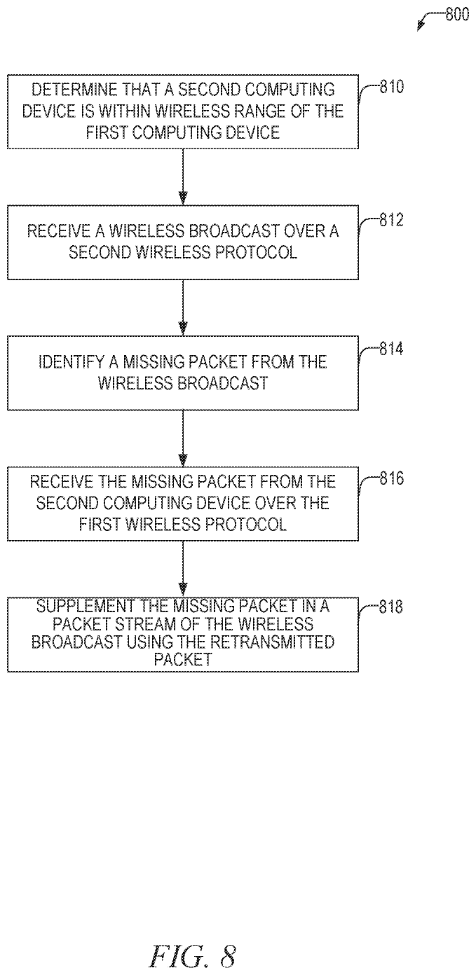

FIG. 8 illustrates a flowchart of a method 800 of a first computing device receiving a retransmission from a second computing device according to some examples of the present disclosure. At operation 810, the first computing device may determine that a second computing device is within a wireless range of the first computing device. For example, using the same methods for operation 710 of FIG. 7 such as using wireless messages of a first wireless protocol. At operation 812 the first device may receive a wireless broadcast addressed to the first device over a second wireless protocol.

At operation 814, the first computing device may identify a missing or damaged packet from the wireless broadcast. For example, the packet was not received, would not decode, could not be demodulated, did not pass error checks, or the like. At operation 816, the first wireless device may receive the missing packet from the second computing device over the first wireless protocol. In some examples, the missing packet may be received responsive to a request to the second computing device, a broadcast or multicast request (e.g., to all members of the neighbor group); or the like. In other examples, one or more other members of the neighbor group may always transmit packets addressed to the first computing device that it receives over the first wireless protocol. At operation 818 the first computing device may supplement the missing packet in a packet stream of the wireless broadcast using the retransmitted packet. For example, as shown in FIG. 6.

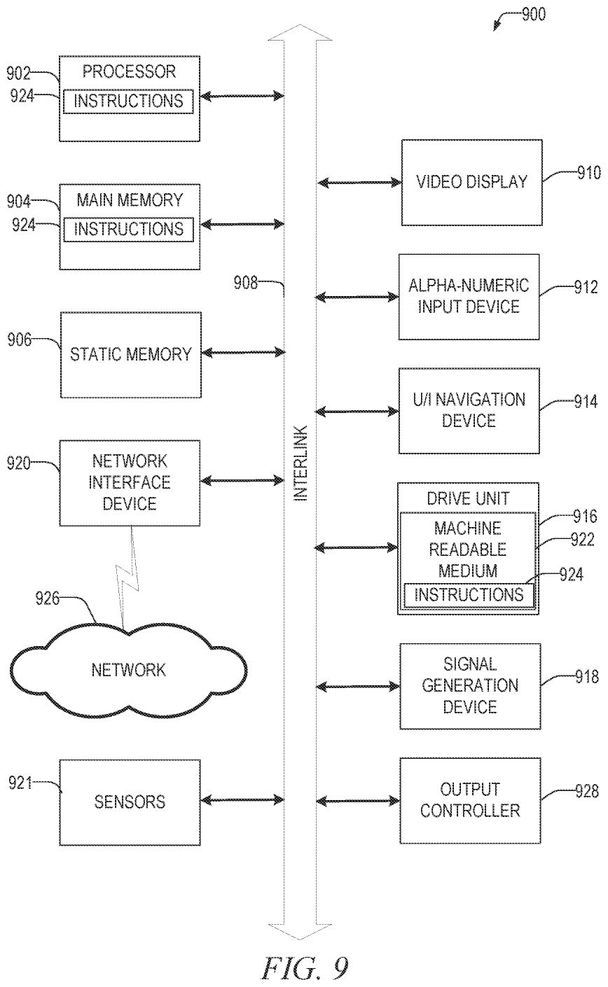

FIG. 9 illustrates a block diagram of an example machine 900 upon which any one or more of the techniques (e.g., methodologies) discussed herein may be performed. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be in the form of a wireless computing device, a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 900 may be examples of computing devices 112, 114, 116, 118, 212, 214, 216, 218, 412, 414, 416, 418, 510, 614, 616; examples of transmitters 410, 602; may create and/or store the data structures of FIG. 3; be configured to include the components of FIG. 5; implement the streams of FIG. 6; and be configured to implement the methods of FIGS. 7 and 8; and the like. As used herein, computing devices may be stationary computing devices, mobile devices, or the like.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 900 may include one or more hardware processors, such as processor 902. Processor 902 may be a central processing unit (CPU), a graphics processing unit (GPU), a hardware processor core, or any combination thereof. Machine 900 may include a main memory 904 and a static memory 906, some or all of which may communicate with each other via an interlink (e.g., bus) 908. Examples of main memory 904 may include Synchronous Dynamic Random-Access Memory (SDRAM), such as Double Data Rate memory, such as DDR4 or DDR5. Interlink 908 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 900 may further include a display unit 910, an alphanumeric input device 912 (e.g., a keyboard), and a user interface (UI) navigation device 914 (e.g., a mouse). In an example, the display unit 910, input device 912 and UI navigation device 914 may be a touch screen display. The machine 900 may additionally include a storage device (e.g., drive unit) 916, a signal generation device 918 (e.g., a speaker), a network interface device 920, and one or more sensors 921, such as a global positioning system (GPS) sensor, compass, accelerometer, or other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 916 may constitute machine readable media.

While the machine readable medium 922 is illustrated as a single medium, the term “machine readable medium” may include a single medium or multiple media (e.g., a centralized or distributed database, and/or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 924 may further be transmitted or received over a communications network 926 using a transmission medium via the network interface device 920. The Machine 900 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. In some examples, the network interface device 920 may wirelessly communicate using Multiple User MIMO techniques.

Example 1 is a method of enhancing a reliability of a wireless transmission to a receiver, the method comprising: at a first computing device: determining that a second computing device is within a wireless communication range of the first computing device based upon one or more wireless messages exchanged over a first wireless protocol; receiving, a wireless broadcast transmission addressed to the second computing device from a wireless transmitter over a second wireless protocol, the wireless broadcast transmission comprising at least one packet, the wireless transmitter not part of the first computing device or the second computing device; retransmitting the packet to the second computing device over the first wireless protocol responsive to the second computing device being determined to be within the wireless communication range of the first computing device; determining that the second computing device is no longer within the wireless communication range of the first computing device; receiving, a second wireless broadcast transmission addressed to the second computing device from the wireless transmitter over the second wireless protocol, the second wireless broadcast transmission comprising at least one second packet; and not retransmitting the packet to the second computing device over the first wireless protocol based upon the second computing device being determined to not being within the wireless communication range of the first computing device.

In Example 2, the subject matter of Example 1 includes, wherein determining that the second computing device is within the wireless communication range of the first computing device based upon the one or more wireless messages exchanged over the first wireless protocol comprises sending a discovery message and receiving a discovery reply message.

In Example 3, the subject matter of Example 2 includes, wherein the discovery reply message includes an address of the second computing device on the second wireless protocol and wherein receiving the wireless broadcast transmission addressed to the second computing device from the wireless transmitter over the second wireless protocol comprises searching for signals over the second wireless protocol addressed to the address of the second computing device on the second wireless protocol.

In Example 4, the subject matter of Examples 1-3 includes, wherein the method further comprises: receiving a retransmission request from the second computing device for the packet; and wherein retransmitting the packet to the second computing device is responsive to the retransmission request.

In Example 5, the subject matter of Examples 1-4 includes, wherein retransmitting the packet to the second computing device is done responsive to the receiving the wireless broadcast transmission addressed to the second computing device and without a request from the second computing device.

In Example 6, the subject matter of Example 5 includes, wherein retransmitting the packet comprises waiting a random delay period prior to retransmitting the packet.

In Example 7, the subject matter of Examples 1-6 includes, wherein determining that the second computing device is no longer within the wireless communication range of the first computing device comprises determining that a signal property of a received communication from the second computing device no longer meets a specified threshold.

Example 8 is a computing device for enhancing a reliability of a wireless transmission to a receiver, the computing device comprising: a processor; a memory device, storing instructions, which when executed by the processor, cause the computing device to perform operations comprising: determining that a second computing device is within a wireless communication range of the computing device based upon one or more wireless messages exchanged over a first wireless protocol; receiving, a wireless broadcast transmission addressed to the second computing device from a wireless transmitter over a second wireless protocol, the wireless broadcast transmission comprising at least one packet, the wireless transmitter not part of the computing device or the second computing device; retransmitting the packet to the second computing device over the first wireless protocol responsive to the second computing device being determined to be within the wireless communication range of the computing device; determining that the second computing device is no longer within the wireless communication range of the computing device; receiving, a second wireless broadcast transmission addressed to the second computing device from the wireless transmitter over the second wireless protocol, the second wireless broadcast transmission comprising at least one second packet; and not retransmitting the packet to the second computing device over the first wireless protocol based upon the second computing device being determined to not being within the wireless communication range of the computing device.

In Example 9, the subject matter of Example 8 includes, wherein the operation of determining that the second computing device is within the wireless communication range of the computing device based upon the one or more wireless messages exchanged over the first wireless protocol comprises sending a discovery message and receiving a discovery reply message.

In Example 10, the subject matter of Example 9 includes, wherein the discovery reply message includes an address of the second computing device on the second wireless protocol and wherein the operation of receiving the wireless broadcast transmission addressed to the second computing device from the wireless transmitter over the second wireless protocol comprises searching for signals over the second wireless protocol addressed to the address of the second computing device on the second wireless protocol.

In Example 11, the subject matter of Examples 8-10 includes, wherein the operations further comprise receiving a retransmission request from the second computing device for the packet; and wherein the operation of retransmitting the packet to the second computing device is responsive to the retransmission request.

In Example 12, the subject matter of Examples 8-11 includes, wherein the operation of retransmitting the packet to the second computing device is done responsive to the receiving the wireless broadcast transmission addressed to the second computing device and without a request from the second computing device.

In Example 13, the subject matter of Example 12 includes, wherein the operation of retransmitting the packet comprises waiting a random delay period prior to retransmitting the packet.

In Example 14, the subject matter of Examples 8-13 includes, wherein the operation of determining that the second computing device is no longer within the wireless communication range of the computing device comprises determining that a signal property of a received communication from the second computing device no longer meets a specified threshold.

Example 15 is a machine-readable medium, storing instructions for enhancing a reliability of a wireless transmission to a receiver, the instructions, which when executed by a first computing device cause the first computing device to perform operations comprising: determining that a second computing device is within a wireless communication range of the first computing device based upon one or more wireless messages exchanged over a first wireless protocol; receiving, a wireless broadcast transmission addressed to the second computing device from a wireless transmitter over a second wireless protocol, the wireless broadcast transmission comprising at least one packet, the wireless transmitter not part of the first computing device or the second computing device; retransmitting the packet to the second computing device over the first wireless protocol responsive to the second computing device being determined to be within the wireless communication range of the first computing device; determining that the second computing device is no longer within the wireless communication range of the first computing device; receiving, a second wireless broadcast transmission addressed to the second computing device from the wireless transmitter over the second wireless protocol, the second wireless broadcast transmission comprising at least one second packet; and not retransmitting the packet to the second computing device over the first wireless protocol based upon the second computing device being determined to not being within the wireless communication range of the first computing device.

In Example 16, the subject matter of Example 15 includes, wherein the operation of determining that the second computing device is within the wireless communication range of the first computing device based upon the one or more wireless messages exchanged over the first wireless protocol comprises sending a discovery message and receiving a discovery reply message.

In Example 17, the subject matter of Example 16 includes, wherein the discovery reply message includes an address of the second computing device on the second wireless protocol and wherein the operation of receiving the wireless broadcast transmission addressed to the second computing device from the wireless transmitter over the second wireless protocol comprises searching for signals over the second wireless protocol addressed to the address of the second computing device on the second wireless protocol.

In Example 18, the subject matter of Examples 15-17 includes, wherein the operations further comprise receiving a retransmission request from the second computing device for the packet; and wherein the operation of retransmitting the packet to the second computing device is responsive to the retransmission request.

In Example 19, the subject matter of Examples 15-18 includes, wherein the operation of retransmitting the packet to the second computing device is done responsive to the receiving the wireless broadcast transmission addressed to the second computing device and without a request from the second computing device.

In Example 20, the subject matter of Example 19 includes, wherein the operation of retransmitting the packet comprises waiting a random delay period prior to retransmitting the packet.

In Example 21, the subject matter of Examples 15-20 includes, wherein the operation of determining that the second computing device is no longer within the wireless communication range of the first computing device comprises determining that a signal property of a received communication from the second computing device no longer meets a specified threshold.

Example 22 is a device for enhancing a reliability of a wireless transmission to a receiver, the device comprising: means for determining that a second computing device is within a wireless communication range of the first computing device based upon one or more wireless messages exchanged over a first wireless protocol; means for receiving, a wireless broadcast transmission addressed to the second computing device from a wireless transmitter over a second wireless protocol, the wireless broadcast transmission comprising at least one packet, the wireless transmitter not part of the first computing device or the second computing device; means for retransmitting the packet to the second computing device over the first wireless protocol responsive to the second computing device being determined to be within the wireless communication range of the first computing device; means for determining that the second computing device is no longer within the wireless communication range of the first computing device; means for receiving, a second wireless broadcast transmission addressed to the second computing device from the wireless transmitter over the second wireless protocol, the second wireless broadcast transmission comprising at least one second packet; and means for not retransmitting the packet to the second computing device over the first wireless protocol based upon the second computing device being determined to not being within the wireless communication range of the first computing device.

In Example 23, the subject matter of Example 22 includes, wherein the means for determining that the second computing device is within the wireless communication range of the first computing device based upon the one or more wireless messages exchanged over the first wireless protocol comprises means for sending a discovery message and receiving a discovery reply message.

In Example 24, the subject matter of Example 23 includes, wherein the discovery reply message includes an address of the second computing device on the second wireless protocol and wherein the means for receiving the wireless broadcast transmission addressed to the second computing device from the wireless transmitter over the second wireless protocol comprises means for searching for signals over the second wireless protocol addressed to the address of the second computing device on the second wireless protocol.

In Example 25, the subject matter of Examples 22-24 includes, wherein the device further comprises means for receiving a retransmission request from the second computing device for the packet; and wherein retransmitting the packet to the second computing device is responsive to the retransmission request.

In Example 26, the subject matter of Examples 22-25 includes, wherein retransmitting the packet to the second computing device is done responsive to the receiving the wireless broadcast transmission addressed to the second computing device and without a request from the second computing device.

In Example 27, the subject matter of Example 26 includes, wherein the means for retransmitting the packet comprises means for waiting a random delay period prior to retransmitting the packet.

In Example 28, the subject matter of Examples 22-27 includes, wherein the means for determining that the second computing device is no longer within the wireless communication range of the first computing device comprises means for determining that a signal property of a received communication from the second computing device no longer meets a specified threshold.

Example 29 is at least one machine-readable medium including instructions that, when executed by processing circuitry, cause the processing circuitry to perform operations to implement of any of Examples 1-28.

Example 30 is an apparatus comprising means to implement of any of Examples 1-28.

Example 31 is a system to implement of any of Examples 1-28.

Example 32 is a method to implement of any of Examples 1-28.

What is claimed is:

1. A method of enhancing a reliability of a wireless transmission to a receiver, the method comprising:
at a first computing device:
determining that a second computing device is within a wireless communication range of the first computing device based upon one or more wireless messages exchanged over a first wireless protocol;
receiving, a wireless broadcast transmission addressed to the second computing device from a wireless transmitter over a second wireless protocol, the wireless broadcast transmission comprising at least one packet, the wireless transmitter not part of the first computing device or the second computing device;
retransmitting the packet to the second computing device over the first wireless protocol responsive to the second computing device being determined to be within the wireless communication range of the first computing device;
determining that the second computing device is no longer within the wireless communication range of the first computing device;
receiving, a second wireless broadcast transmission addressed to the second computing device from the wireless transmitter over the second wireless protocol, the second wireless broadcast transmission comprising at least one second packet; and
not retransmitting the packet to the second computing device over the first wireless protocol based upon the second computing device being determined to not being within the wireless communication range of the first computing device.

2. The method of claim 1, wherein determining that the second computing device is within the wireless communication range of the first computing device based upon the one or more wireless messages exchanged over the first wireless protocol comprises sending a discovery message and receiving a discovery reply message.

3. The method of claim 2, wherein the discovery reply message includes an address of the second computing device on the second wireless protocol and wherein receiving the wireless broadcast transmission addressed to the second computing device from the wireless transmitter over the second wireless protocol comprises searching for signals over the second wireless protocol addressed to the address of the second computing device on the second wireless protocol.

4. The method of claim 1, wherein the method further comprises:
receiving a retransmission request from the second computing device for the packet; and wherein retransmitting the packet to the second computing device is responsive to the retransmission request.

5. The method of claim 1, wherein retransmitting the packet to the second computing device is done responsive to the receiving the wireless broadcast transmission addressed to the second computing device and without a request from the second computing device.

6. The method of claim 5, wherein retransmitting the packet comprises waiting a random delay period prior to retransmitting the packet.

7. The method of claim 1, wherein determining that the second computing device is no longer within the wireless communication range of the first computing device comprises determining that a signal property of a received communication from the second computing device no longer meets a specified threshold.

8. A computing device for enhancing a reliability of a wireless transmission to a receiver, the computing device comprising:
a processor;
a memory device, storing instructions, which when executed by the processor, cause the computing device to perform operations comprising:
determining that a second computing device is within a wireless communication range of the computing device based upon one or more wireless messages exchanged over a first wireless protocol;
receiving, a wireless broadcast transmission addressed to the second computing device from a wireless transmitter over a second wireless protocol, the wireless broadcast transmission comprising at least one packet, the wireless transmitter not part of the computing device or the second computing device;
retransmitting the packet to the second computing device over the first wireless protocol responsive to the second computing device being determined to be within the wireless communication range of the computing device;
determining that the second computing device is no longer within the wireless communication range of the computing device;
receiving, a second wireless broadcast transmission addressed to the second computing device from the wireless transmitter over the second wireless protocol, the second wireless broadcast transmission comprising at least one second packet; and
not retransmitting the packet to the second computing device over the first wireless protocol based upon the second computing device being determined to not being within the wireless communication range of the computing device.

9. The computing device of claim 8, wherein the operation of determining that the second computing device is within the wireless communication range of the computing device based upon the one or more wireless messages exchanged over the first wireless protocol comprises sending a discovery message and receiving a discovery reply message.

10. The computing device of claim 9, wherein the discovery reply message includes an address of the second computing device on the second wireless protocol and wherein the operation of receiving the wireless broadcast transmission addressed to the second computing device from the wireless transmitter over the second wireless protocol comprises searching for signals over the second wireless protocol addressed to the address of the second computing device on the second wireless protocol.

11. The computing device of claim 8, wherein the operations further comprise receiving a retransmission request from the second computing device for the packet; and wherein the operation of retransmitting the packet to the second computing device is responsive to the retransmission request.

12. The computing device of claim 8, wherein the operation of retransmitting the packet to the second computing device is done responsive to the receiving the wireless broadcast transmission addressed to the second computing device and without a request from the second computing device.

13. The computing device of claim 12, wherein the operation of retransmitting the packet comprises waiting a random delay period prior to retransmitting the packet.

14. The computing device of claim 8, wherein the operation of determining that the second computing device is no longer within the wireless communication range of the computing device comprises determining that a signal property of a received communication from the second computing device no longer meets a specified threshold.

15. A device for enhancing a reliability of a wireless transmission to a receiver, the device comprising:
means for determining that a second computing device is within a wireless communication range of the first computing device based upon one or more wireless messages exchanged over a first wireless protocol;
means for receiving, a wireless broadcast transmission addressed to the second computing device from a wireless transmitter over a second wireless protocol, the wireless broadcast transmission comprising at least one packet, the wireless transmitter not part of the first computing device or the second computing device;
means for retransmitting the packet to the second computing device over the first wireless protocol responsive to the second computing device being determined to be within the wireless communication range of the first computing device;
means for determining that the second computing device is no longer within the wireless communication range of the first computing device;
means for receiving, a second wireless broadcast transmission addressed to the second computing device from the wireless transmitter over the second wireless protocol, the second wireless broadcast transmission comprising at least one second packet; and
means for not retransmitting the packet to the second computing device over the first wireless protocol based upon the second computing device being determined to not being within the wireless communication range of the first computing device.

16. The device of claim 15, wherein the means for determining that the second computing device is within the wireless communication range of the first computing device based upon the one or more wireless messages exchanged over the first wireless protocol comprises means for sending a discovery message and receiving a discovery reply message.

17. The device of claim 16, wherein the discovery reply message includes an address of the second computing device on the second wireless protocol and wherein the means for receiving the wireless broadcast transmission addressed to the second computing device from the wireless transmitter over the second wireless protocol comprises means for searching for signals over the second wireless protocol addressed to the address of the second computing device on the second wireless protocol.

18. The device of claim 15, wherein the device further comprises means for receiving a retransmission request from the second computing device for the packet; and wherein retransmitting the packet to the second computing device is responsive to the retransmission request.

19. The device of claim 15, wherein retransmitting the packet to the second computing device is done responsive to the receiving the wireless broadcast transmission addressed to the second computing device and without a request from the second computing device.

20. The device of claim 19, wherein the means for retransmitting the packet comprises means for waiting a random delay period prior to retransmitting the packet.
